(19) United States
(12) Patent Application Publication
(10) Pub. No.: US 2023/0105407 A1
(43) Pub. Date: Apr. 6, 2023

(54) ELECTRIC MACHINE FOR VEHICLE

(71) Applicant: FORD GLOBAL TECHNOLOGIES, LLC, Dearborn, MI (US)

(72) Inventors: Franco Leonardi, Dearborn Heights, MI (US); Michael W. Degner, Novi, MI (US)

(21) Appl. No.: 17/491,976

(22) Filed: Oct. 1, 2021

(51) Int. Cl. H02K 1/20; H02K 9/19

(52) U.S. Cl. CPC H02K 1/20; H02K 9/19

(57) ABSTRACT

A vehicle electric machine includes a housing, a stator supporting windings and disposed in the housing. The stator defines axial cooling channels having first ends located on a first end face of the stator and second ends located on a second end face of the stator. A plug is disposed in the second end of one of the axial channels and having an orifice.

### TECHNICAL FIELD

The present disclosure relates to electric machines, for use with electric and hybrid-electric vehicles, that are capable of acting either as a motor or as a generator.

### BACKGROUND

Vehicles such as battery-electric vehicles and hybrid-electric vehicles contain a traction-battery assembly to act as an energy source. The traction-battery assembly, for example, is electrically connected to an electric machine that provides torque to driven wheels. The traction-battery assembly may include components and systems to assist in managing vehicle performance and operations. It may also include high-voltage components, and an air or liquid thermal-management system to control temperature.

Electric machines typically include a stator and a rotor that cooperate to convert electrical energy into mechanical motion or vice versa. Electric machines may include thermal-management systems to cool the stator, rotor, or both.

### SUMMARY

According to one embodiment, a vehicle electric machine includes a housing, a stator supporting windings and disposed in the housing. The stator defines axial cooling channels having first ends located on a first end face of the stator and second ends located on a second end face of the stator. A plug is disposed in the second end of one of the axial channels and having an orifice.

According to another embodiment, a vehicle electric machine includes a housing, a stator core disposed in the housing and having an inner diameter defining a plurality of slots, an outer diameter, and mounting ears each disposed radially outboard of the outer diameter and each defining at least one first cooling channel extending axially. Windings are disposed in the slots. An end cover defines a recessed cavity configured to receive the windings, a second cooling channel extending circumferentially around a perimeter of the cavity, and third cooling channels extending from the second cooling channel to the recessed cavity, wherein the end cover is connected to the housing such that the first cooling channels are in fluid communication with the second cooling channel.

According to yet another embodiment, a vehicle electric machine includes a housing, a stator core disposed in the housing and including mounting portions each defining at least one axial cooling channel, and windings disposed on the stator core. An end cover defines a recessed cavity configured to receive the winding and a circumferential cooling channel extending around a perimeter of the cavity. The end cover is connected to the housing such that the axial cooling channels are in fluid communication with the circumferential cooling channel. A plug disposed in one of the axial cooling channels and defines an orifice.

### BRIEF DESCRIPTION OF THE DRAWINGS

FIG. 1 is a schematic diagram of an example hybrid vehicle.

FIG. 2 is side view, in cross section, of a portion of an example electric machine.

FIG. 3 is a perspective view of a stator core disposed in a housing.

FIG. 4 a perspective view of an end cover.

FIG. 5 is a negative of the cooling circuit of the electric machine.

FIG. 6 is a perspective view of the electric machine showing example plugs of the cooling circuit.

FIG. 7 is a cross-sectional view of a plug according to one embodiment.

FIG. 8 is a cross-sectional view of a plug according to another embodiment.

FIG. 9 is a perspective view of a helical plug rod.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Directional terms used herein are made with reference to the views and orientations shown in the exemplary figures. A central axis is shown in the figures and described below. Terms such as “outer” and “inner” are relative to the central axis. For example, an “outer” surface means that the surfaces faces away from the central axis, or is outboard of another “inner” surface. Terms such as “radial,” “diameter,” “circumference,” etc. also are relative to the central axis. The terms “front,” “rear,” “upper” and “lower” designate directions in the drawings to which reference is made. The terms, connected, attached, etc., refer to directly or indirectly connected, attached, etc., unless otherwise indicated explicitly or by context.

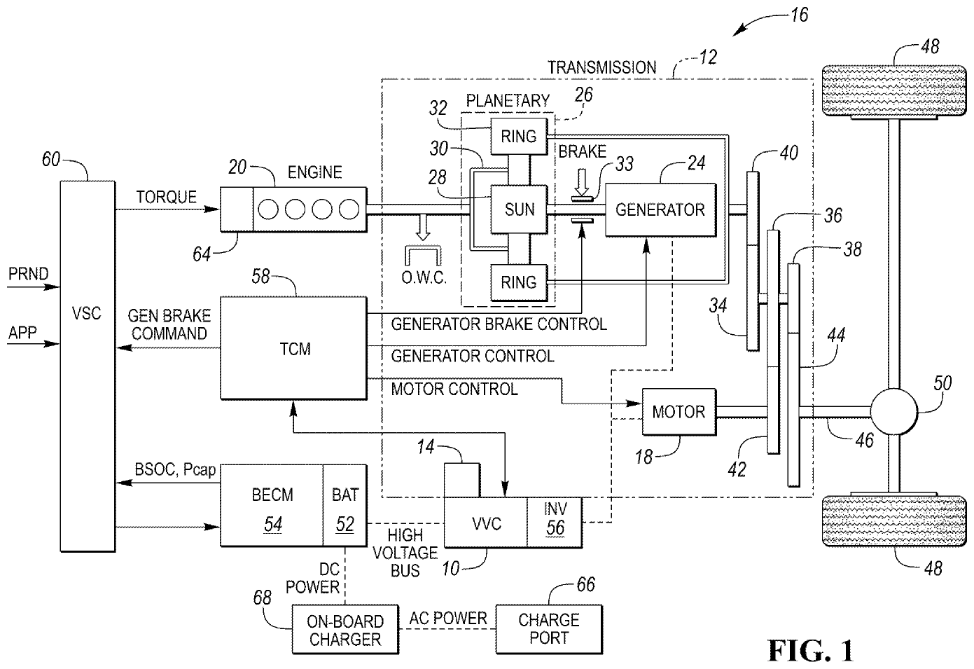

An example plugin-hybrid-electric vehicle (PHEV) is depicted in FIG. 1 and referred to generally as a vehicle 16. The vehicle 16 includes a transmission 12 and is propelled by at least one electric machine 18 with selective assistance from an internal combustion engine 20. The electric machine 18 may be an alternating current (AC) electric motor depicted as “motor” 18 in FIG. 1. The electric machine 18 receives electrical power and provides torque for vehicle propulsion. The electric machine 18 also functions as a generator for converting mechanical power into electrical power through regenerative braking.

The transmission 12 may be a power-split configuration. The transmission 12 includes the first electric machine 18 and a second electric machine 24. The second electric machine 24 may be an AC electric motor depicted as “generator” 24 in FIG. 1. Like the first electric machine 18, the second electric machine 24 receives electrical power and provides output torque. The second electric machine 24 also functions as a generator for converting mechanical power into electrical power and optimizing power flow through the transmission 12. In other embodiments, the transmission does not have a power-split configuration.

The transmission 12 may include a planetary gear unit 26, which includes a sun gear 28, a planet carrier 30, and a ring gear 32. The sun gear 28 is connected to an output shaft of the second electric machine 24 for receiving generator torque. The planet carrier 30 is connected to an output shaft of the engine 20 for receiving engine torque. The planetary gear unit 26 combines the generator torque and the engine torque and provides a combined output torque about the ring gear 32. The planetary gear unit 26 functions as a continuously variable transmission, without any fixed or “step” ratios.

The transmission 12 may also include a one-way clutch (O.W.C.) and a generator brake 33. The O.W.C. is coupled to the output shaft of the engine 20 to only allow the output shaft to rotate in one direction. The O.W.C. prevents the transmission 12 from back-driving the engine 20. The generator brake 33 is coupled to the output shaft of the second electric machine 24. The generator brake 33 may be activated to “brake” or prevent rotation of the output shaft of the second electric machine 24 and of the sun gear 28. Alternatively, the O.W.C. and the generator brake 33 may be eliminated and replaced by control strategies for the engine 20 and the second electric machine 24.

The transmission 12 may further include a countershaft having intermediate gears including a first gear 34, a second gear 36 and a third gear 38. A planetary output gear 40 is connected to the ring gear 32. The planetary output gear 40 meshes with the first gear 34 for transferring torque between the planetary gear unit 26 and the countershaft. An output gear 42 is connected to an output shaft of the first electric machine 18. The output gear 42 meshes with the second gear 36 for transferring torque between the first electric machine 18 and the countershaft. A transmission output gear 44 is connected to a driveshaft 46. The driveshaft 46 is coupled to a pair of driven wheels 48 through a differential 50. The transmission output gear 44 meshes with the third gear 38 for transferring torque between the transmission 12 and the driven wheels 48.

The vehicle 16 includes an energy storage device, such as a traction battery 52 for storing electrical energy. The battery 52 is a high-voltage battery that is capable of outputting electrical power to operate the first electric machine 18 and the second electric machine 24. The battery 52 also receives electrical power from the first electric machine 18 and the second electric machine 24 when they are operating as generators. The battery 52 is a battery pack made up of several battery modules (not shown), where each battery module contains a plurality of battery cells (not shown). Other embodiments of the vehicle 16 contemplate different types of energy storage devices, such as capacitors and fuel cells (not shown) that supplement or replace the battery 52. A high-voltage bus electrically connects the battery 52 to the first electric machine 18 and to the second electric machine 24.

The vehicle includes a battery energy control module (BECM) 54 for controlling the battery 52. The BECM 54 receives input that is indicative of vehicle conditions and battery conditions, such as battery temperature, voltage and current. The BECM 54 calculates and estimates battery parameters, such as battery state of charge and the battery power capability. The BECM 54 provides output (BSOC, P_{cap}) that is indicative of a battery state of charge (BSOC) and a battery power capability (P_{cap}) to other vehicle systems and controllers.

The vehicle 16 includes a DC-DC converter or variable voltage converter (VVC) 10 and an inverter 56. The VVC 10 and the inverter 56 are electrically connected between the traction battery 52 and the first electric machine 18, and between the battery 52 and the second electric machine 24. The VVC 10 “boosts” or increases the voltage potential of the electrical power provided by the battery 52. The VVC 10 also “bucks” or decreases the voltage potential of the electrical power provided to the battery 52, according to one or more embodiments. The inverter 56 inverts the DC power supplied by the main battery 52 (through the VVC 10) to AC power for operating the electric machines 18, 24. The inverter 56 also rectifies AC power provided by the electric machines 18, 24, to DC for charging the traction battery 52. Other embodiments of the transmission 12 include multiple inverters (not shown), such as one invertor associated with each electric machine 18, 24. The VVC 10 includes an inductor assembly 14.

The transmission 12 includes a transmission control module (TCM) 58 for controlling the electric machines 18, 24, the VVC 10 and the inverter 56. The TCM 58 is configured to monitor, among other things, the position, speed, and power consumption of the electric machines 18, 24. The TCM 58 also monitors electrical parameters (e.g., voltage and current) at various locations within the VVC 10 and the inverter 56. The TCM 58 provides output signals corresponding to this information to other vehicle systems.

The vehicle 16 includes a vehicle system controller (VSC) 60 that communicates with other vehicle systems and controllers for coordinating their function. Although it is shown as a single controller, the VSC 60 may include multiple controllers that may be used to control multiple vehicle systems according to an overall vehicle control logic, or software.

The vehicle controllers, including the VSC 60 and the TCM 58 generally includes any number of microprocessors, ASICs, ICs, memory (e.g., FLASH, ROM, RAM, EPROM and/or EEPROM) and software code to co-act with one another to perform a series of operations. The controllers also include predetermined data, or “look up tables” that are based on calculations and test data and stored within the memory. The VSC 60 communicates with other vehicle systems and controllers (e.g., the BECM 54 and the TCM 58) over one or more wired or wireless vehicle connections using common bus protocols (e.g., CAN and LIN). The VSC 60 receives input (PRND) that represents a current position of the transmission 12 (e.g., park, reverse, neutral or drive). The VSC 60 also receives input (APP) that represents an accelerator pedal position. The VSC 60 provides output that represents a desired wheel torque, desired engine speed, and generator brake command to the TCM 58, and contactor control to the BECM 54.

The vehicle 16 includes an engine control module (ECM) 64 for controlling the engine 20. The VSC 60 provides output (desired engine torque) to the ECM 64 that is based on a number of input signals including APP, and corresponds to a driver's request for vehicle propulsion.

If the vehicle 16 is a PHEV, the battery 52 may periodically receive AC energy from an external power supply or grid, via a charge port 66. The vehicle 16 also includes an on-board charger 68, which receives the AC energy from the charge port 66. The charger 68 is an AC/DC converter which converts the received AC energy into DC energy suitable for charging the battery 52. In turn, the charger 68 supplies the DC energy to the battery 52 during recharging. Although illustrated and described in the context of a PHEV 16, it is understood that the electric machines 18, 24 may be implemented on other types of electric vehicles, such as a hybrid-electric vehicle or a fully electric vehicle.

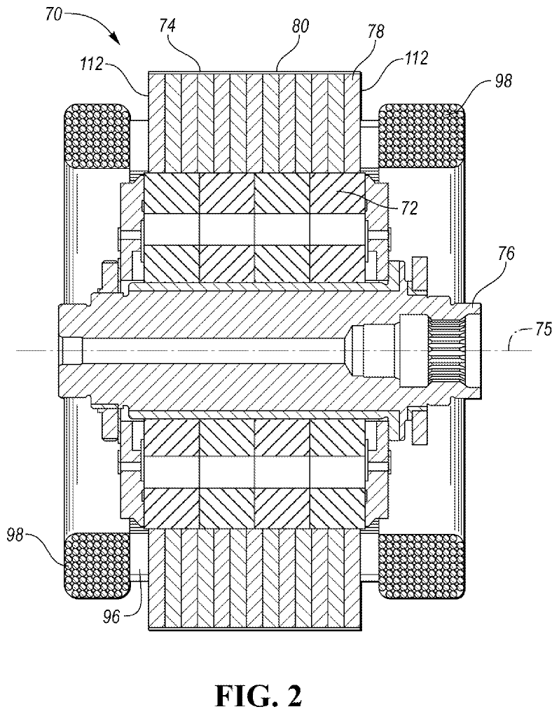

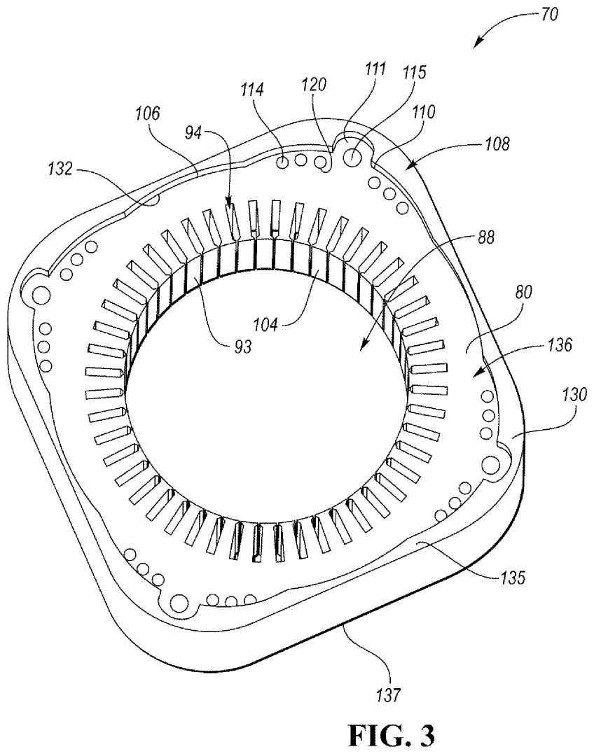

Referring to FIGS. 2 and 3, an example electric machine 70 includes a stator 74 having a plurality of laminations 78. The electric machine 70 has a central axis 75. Each of the laminations 78 includes a front side and a back side. When stacked, the front and back sides are disposed against adjacent front and back sides to form a stator core 80. Each of the laminations 78 may define a hollow center.

Each lamination 78 includes an inner diameter defining a plurality of teeth extending radially inward toward the inner diameter. Adjacent teeth cooperate to define slots. The teeth and the slots of each lamination 78 are aligned with adjacent laminations to define stator teeth 93 and stator slots 94 extending axially through the stator core 80 between the opposing end faces 112. The end faces 112, 113 define the opposing ends of the core 80 and are formed by the first and last laminations of the stator core 80. A plurality of windings (also known as coils, wires, or conductors) 96 are wrapped around the stator core 80 and are disposed within the stator slots 94. The windings 96 may be disposed in an insulating material (not shown). Portions of the windings 96 generally extend in an axial direction along the stator slots 94. At the end faces 112, 113 of the stator core, the windings bend to extend circumferentially around the end faces 112, 113 of the stator core 80 forming the end windings 98. The windings may be of the distributed, concentrated, or hairpin type.

A rotor 72 is disposed within the cavity 88. The rotor 72 is fixed to a shaft 76 that is operably connected to the gearbox. When current is supplied to the stator 74, a magnetic field is created causing the rotor 72 to spin within the stator 74 generating a torque that is supplied to the gear box via one or more shafts.

The core 80 includes an inner diameter 104 and an outer diameter 106 that are each concentric with the centerline 75. Mounting ears 108 are disposed radially outboard of the outer diameter 106. In the illustrated embodiment, the stator core 80 includes four mounting ears 108. The addition of the mounting ears 108 to the outer diameter 106 creates a generally rectangular cross section. Each of the mounting ears 108 may include an arcuate outer surface 110 and a tab 111 with a bolt hole 115. One or more cooling channels 114 are defined in at least one of the mounting ears 108. The cooling channel(s) 114 extends in the axial direction of the stator core 80 and may extend completely through the core 80 from the first end face 112 to the second end face 115. In the illustrated embodiment, each of the mounting ears 108 includes a plurality of cooling channels 114. The axial channels 114 may have a circular cross section, as shown, or any other suitable shape. As shown, the cooling channels of each ear 108 are grouped into first and second sets 116 and 118 on opposite sides of the tab 111. (Used herein, a “set” includes one or more cooling channels.) In the illustrated embodiment, each set includes a plurality of small circular channels 114, however, these may replace with a single enlarged channel. Each of the cooling channels 114 may be set at a same radial distance from the centerline 75. That is, the inner most points 120 of the cooling channels 114 may all lie on a common circle. A radial distance between the center of the core 80, e.g., centerline 75, and an inner most points 120 of cooling channels 114 is greater than the radial distance between the center of the core and the outer diameter 106. This places the coolant channels 114 out of the yoke portion (region between the outer diameter and the base of the teeth) of the stator core 80. By moving the cooling channels 114 radially outboard of the yoke portion, the flux path of the electric machine is less affected than in designs having cooling channels extending through the yoke portion. Each of the laminations 78 include individual features that cooperate to form the mounting ears and their associated features described above.

The stator core 80 is received within a housing 130 having a sidewall 132 and a cavity 136 configured to receive the stator core 80. The cavity 136 has a shape that substantially matches the shape of the stator core 80. In the illustrated embodiment, the housing 130 has an insertion end 135 and a bottom end 137 that is at least semi-enclosed to include a shoulder or stop for the stator core 80. The stator core 80 is received within the housing 130 through the insertion end 135 and bottoms out on the shoulder/stop.

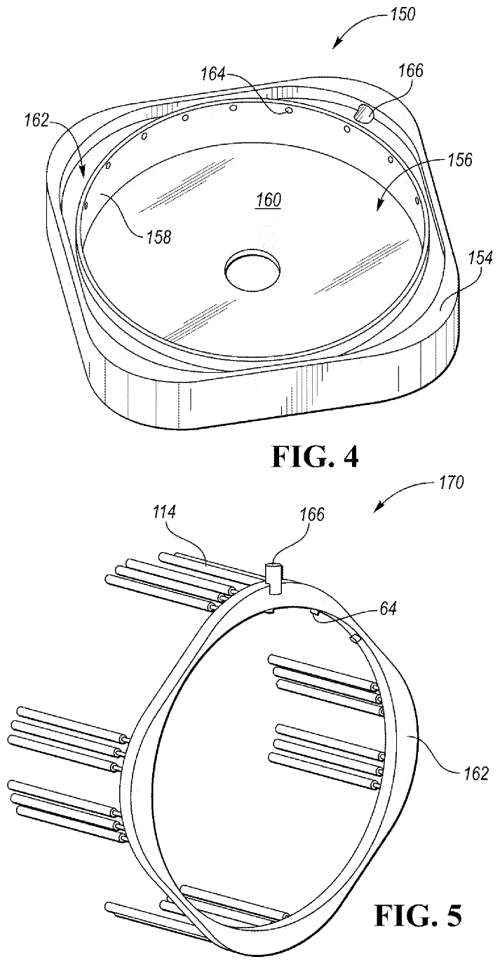

Referring to FIG. 4, the electric machine 70 includes an end cover 150 that connects to the insertion end 152 of the housing 130. The end cover 150 includes a flat face 154 that is configured to engage with the stator core 80 and/or the end 135 of the housing. A cavity 156 is recessed into the flat face 154 to define a void space for the end windings 98 that are received therein. The cavity 156 includes circumferential wall 158 and a radially oriented wall 160. The flat face 154 defines a circumferential cooling channel 162 that surrounds a perimeter of the cavity 156. The circumferential wall 158 may define a plurality of cooling passages 164, e.g., circular holes, that extend between the circular channel 162 and the cavity 156. The cooling passages 164 may extend radially relative to the centerline 75 of the electric machine 70. The cooling passages 164 are configured to circulate fluid, e.g., oil, from the circular channel 162 into the cavity 156 to cool the end windings 98. The end cover 150 may also define a main feed (supply) passage 166 that is in fluid communication with the circular cooling channel 162. The main feed 166 may be radially oriented and extend from a fitting (not shown) connected to the outer surface of the end cover 150. The main feed 166 is configured to connect with a thermal-management system associated with the electric machine 70. Alternatively, the main feed 166 may come in from the top of the end cover 150 or any other suitable orientation.

The diameter of the circumferential cooling channel 162 is sized so that the channel 162 is disposed over the axial channels 114 when the end cover 150 is attached to the housing 130. One or more seals or gaskets (not shown) may be applied between the end cover 150 and the housing 130 and/or the stator core 80 to retain the fluid within the desired channels and passages.

FIG. 5 illustrates a negative of the cooling circuit 170 associated with the electric machine 70. The cooling circuit 170 is configured to circulate a working fluid or coolant through the electric machine to facilitate thermal management thereof. The working fluid or coolant may be oil or any other dielectric fluid. Fluid enters the electric machine 70 through the main feed 166 and then accumulates within the circumferential cooling channel 162. From there, most of the fluid flows through the axial channels 114 to cool the stator core 80 and a lesser portion flows though the passages 164 to spray/drip cool the end windings 98. At the other end of the stator core, the fluid exits the axial channels 114 and is collected into a drain (not shown). As will be disclosed in more detail below, features may be installed at the exit ends of the axial channels 114 to spray cool the end windings on the opposite side of the stator core.

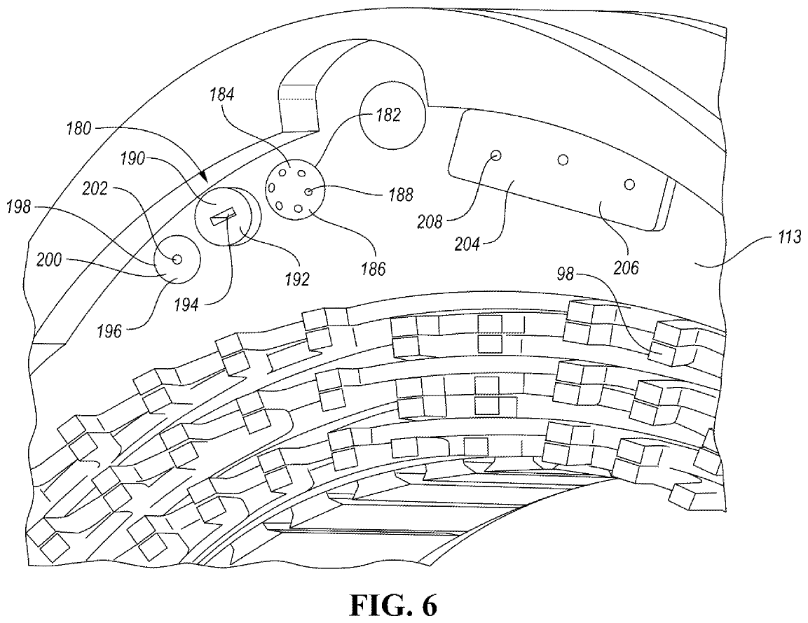

Referring to FIG. 6, one or more plugs 180 may be disposed in one or more of the exit ends 182 of the axial channels 114. FIG. 6 illustrates an electric machine having three different types of plugs 180 for illustrative purposes. In some embodiments, the plugs 180 may all be of the same type, or, alternatively, multiple different types of plugs may be used. The plugs may be used to control fluid flow through the axial channels 114. The plugs may modify the flow rate, pressure, and velocity of the coolant both within the channels 114 and exiting from the plugs 180. For example, the more restrictive plug may induce greater pressure within the axial channel 114 and create a higher velocity spray from the openings of the plug. The more restrictive plug, however, may reduce the flow rate through the cooling circuit 170. Conversely, less restrictive plugs may reduce the pressure within the axial channel creating a lower velocity spray but with a higher overall flow rate for the cooling circuit 170.

A first of the plugs 184 includes a semi-spherical (domed) head 186 defining at least one orifice 188 (multiple in the illustrated embodiment). The orifice 188 extends through the head 186 and is in fluid communication with the axial channel 114. The orifice 188 permits fluid flow through the plug 184. The size, number, and location of the orifices 188 can be adjusted to achieve a desired flow rate, velocity, and pressure of the fluid in the axial channel 114. The orifices 188 may also be used to direct the fluid exiting the axial channel 114. For example, one or more of the orifices 188 may be aimed to spray fluid onto the end windings 98.

A second type of plug 190 may include a flat head 192 that defines a single orifice 194. The orifice 194 may be a rectangular slot formed on a central region of the head 192. Alternatively, the plug 190 may include a plurality of orifices that are either slots, circular holes, or the like. The head 192 may be raised from the end face 113 of the stator core.

A third type of plug 196 may include a head 198 that is fully received within the channel 114 so that the outer surface 200 of the head 198 is flush with the end face 113 (or alternatively 112). In the illustrated embodiment, the plug 196 includes a single orifice in the form of a circular hole 202. This, of course, is just one embodiment. The third plug 196 may include multiple orifices in other embodiments. Additionally, the hole 202 need not be centered so shown.

Another type of plug 204 is configured to block multiple axial channels 114. This type of plug includes an upper plate 206 and posts (not visible) that are received within the individual axial channels 114. The upper plate 206 defines orifices 208 that are in fluid communication with the axial channels allowing the fluid to flow from the axial channels and onto the end windings. In the illustrated embodiment, each orifice 208 is associated with one of the axial channels, however, the upper plate 206 may define multiple orifices associated with each channel 114.

The plugs may be retained within the cooling channels by a variety of different mechanisms. In one embodiment, an adhesive or sealant may be used to retain the plugs within the cooling channels 114. In another embodiment, the plugs may be mechanically joined to the stator core 80 by interference fit, threads, or the like. In some embodiments, an insert may be used to secure the plug to the stator core. For example, an insert may be first assembled within the axial slot. The insert element may include a tapered opening that gradually reduces is in diameter. The plug is receivable within this tapered opening and is secured by interference fit. Alternatively, the insert may define threads that engage with threads of the plug. The plugs of this type may only partially extend into the axial cooling channels 114.

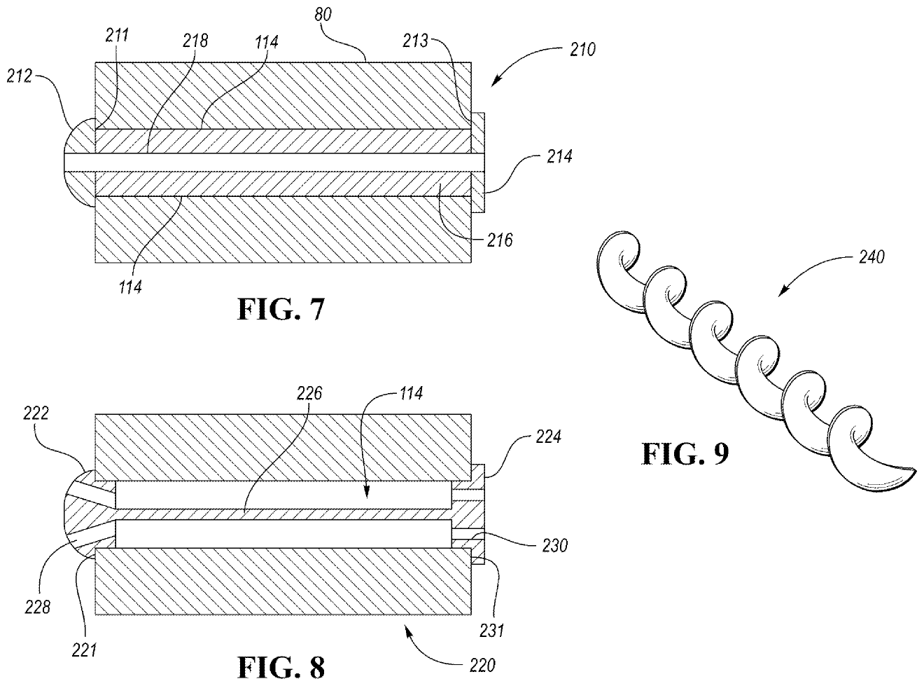

In other embodiments, the plugs may extend a length of the axial cooling channels. FIG. 7 illustrates a cross-sectional view of this design. The stator core 80 supports a plug 210 according to one or more embodiments. The plug 210 includes a head 212 located at the exit end 211 of the axial channel 114, a tail 214 located at the entrance end 213 of the axial channel 114, and a body 216 extending therebetween along a length of the channel 114. In the illustrated example, the body 216 may have a length that substantially matches the length of the stator core 80. The body 216 may be permanently attached to one of the tail and the head and connectable to the other of the tail and the head after insertion into the stator core 80. One or more orifices 218 extend axially through the plug 210. The orifice 218 includes a portion that extends through the tail 214, a portion that extends to the body 216, and a portion that extends through the head 212. In this embodiment, the orifice 218 is the cooling channel as the body 216 of the plug 210 occupies the remaining void space of the cooling channel 114.

FIG. 8 illustrates another example embodiment of a full-length plug 220. The plug 210 includes a head 222 located at the exit end 221 of the axial slot 114, a tail 224 located at the entrance end 231 of the axial slot 114, and a rod 226 connecting therebetween. The rod 226 may be permanently attached to one of the tail and the head and connectable to the other of the tail and the head after insertion into the stator core. In this embodiment, the axial channel 114 still circulates the fluid. The head 222 may define one or more orifices 228 that are off-center, and the tail 224 may define one or more orifices 230 that are off-center. Depending upon the embodiment, the number of orifices 228 in the head 222 may be equal to the number in the tail 224. Alternatively, the number of orifices may differ to create desirable fluid-flow properties. The sizing and location of the orifices in the head 222 and the tail 224 may also be tailored to produce the desired fluid dynamics. The rod 226 may be a cylinder having a constant diameter and a smooth outer surface. Alternatively, the diameter of the rod may increase or decrease along its length to restrict/expand the effective cross-sectional area of the fluid channel 114.

Referring to FIG. 9, another rod 240, that may be used in conjunction with the plug 220, includes features for promoting turbulent flow of the fluid through the cooling channel 114. In the illustrated embodiment, the rod 240 has a helical shape. The helical shape may create a swirling effect within the axial channel to increase the transfer of heat from the stator core 80 to the working fluid. It is to be understood that any of the above-described features of the plugs can be combined in additional combinations that are not explicitly shown or discussed to form further embodiments of the invention.

While example embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A vehicle electric machine comprising:
a housing;
a stator supporting windings and disposed in the housing, the stator defining axial cooling channels having first ends located on a first end face of the stator and second ends located on a second end face of the stator; and
a plug disposed in the second end of one of the axial channels and having an orifice.

2. The vehicle of claim 1, wherein the orifice is a plurality of circular holes.

3. The vehicle of claim 1, wherein the plug includes a helical rod extending into the one of the axial channels.

4. The vehicle of claim 1, wherein the plug includes a head disposed in the second end of the one of the axial channels, a tail disposed in the first end of the one of the axial channels, and a rod connected between the head and the tail.

5. The vehicle of claim 4, wherein the tail defines an orifice.

6. The vehicle of claim 4, wherein a diameter of the rod is less than a diameter of the associated one of the first cooling channels.

7. A vehicle electric machine comprising:
a housing;
a stator core disposed in the housing and including an inner diameter defining a plurality of slots, an outer diameter, and mounting ears each disposed radially outboard of the outer diameter and each defining at least one first cooling channel extending axially;
windings disposed in the slots; and
an end cover defining a recessed cavity configured to receive the windings, a second cooling channel extending circumferentially around a perimeter of the cavity, and third cooling channels extending from the second cooling channel to the recessed cavity, wherein the end cover is connected to the housing such that the first cooling channels are in fluid communication with the second cooling channel.

8. The vehicle electric machine of claim 7, wherein the third cooling channels extend radially.

9. The vehicle electric machine of claim 7, wherein the cavity has a circumferential wall, and the third cooling channels are defined in the wall.

10. The vehicle electric machine of claim 7, wherein each of the mounting ears defines a plurality of the first cooling channels.

11. The vehicle electric machine of claim 7, wherein the at least one first cooling channel has an entrance end on a first end face of the stator core and an exit end on a second end face of the stator core, wherein the entrance end is configured to receive fluid from the second cooling channel and the exit end is configured to supply the fluid to a drain.

12. The vehicle electric machine of claim 11 further comprising a plug disposed in one of the exit ends.

13. The vehicle electric machine of claim 12, wherein the plug defines an orifice.

14. The vehicle electric machine of claim 13, wherein the orifice is configured to spray the fluid towards the windings.

15. The vehicle electric machine of claim 13, wherein the orifice is a plurality of orifices.

16. The vehicle electric machine of claim 12, wherein the plug includes a head disposed in the one of the exit ends and a rod extending into an associated one of the first cooling channels.

17. The vehicle electric machine of claim 16, wherein a diameter of the rod is less than a diameter of the associated one of the first cooling channels.

18. The vehicle electric machine of claim 7 further comprising a helical insert disposed in one of the first cooling channels.

19. The vehicle electric machine of claim 7 further comprising a rotor supported for rotation within the stator core.

20. A vehicle electric machine comprising:
a housing;
a stator core disposed in the housing and including mounting portions each defining at least one axial cooling channel;
windings disposed on the stator core;
an end cover defining a recessed cavity configured to receive the winding and a circumferential cooling channel extending around a perimeter of the cavity, wherein the end cover is connected to the housing such that the axial cooling channels are in fluid communication with the circumferential cooling channel; and
a plug disposed in one of the axial cooling channels and defining an orifice.
